(19) United States
(12) Patent Application Publication
(10) Pub. No.: US 2002/0083454 A1
(43) Pub. Date: Jun. 27, 2002

(54) On-demand method and system for entertaining a user

(76) Inventor: Mark D. Braxton, Bracknell (GB)

Correspondence Address: ANTHONY LUKE SIMON, General Motors Corporation, Legal Staff Mail Code 482-C23-B21, P.O. Box 300, Detroit, MI, 48265-3000, US

(21) Appl. No.: 09/745,585

(22) Filed: Dec. 21, 2000

(51) Int. Cl. H04N 7/173; G06F 3/00; H04N 7/16; H04N 5/445

(52) U.S. Cl. 725/58; 725/86; 725/89

(57) ABSTRACT

An on-demand method of entertaining a user using an entertainment device comprising the steps of: providing a conventional entertainment to the user; monitoring a remote broadcast of compressed entertainment data; receiving the compressed entertainment data; storing the received compressed entertainment data; providing the operator with a selection of choices corresponding to stored entertainment data; receiving a user input designating an entertainment choice representing one of the choices corresponding to stored entertainment data; and using the stored entertainment data corresponding to the entertainment choice for to provide entertainment to the user.

### TECHNICAL FIELD

This invention relates to an on-demand method and system for entertaining a user.

### BACKGROUND OF THE INVENTION

It is known in the broadcast industry to provide broadcast programs over public airways, through proprietary cable systems, over computer networks such as the Internet, and through satellite broadcast. Typically, cable systems, satellite broadcasts systems, and some Internet broadcast systems are user pay systems requiring either monthly subscriptions, per use payment, or both.

It is known for the in-home game industry to provide in-home arcade style games with expanded capabilities such as playing DVD movies and compact audio discs.

It is known for the in-home entertainment industry to provide devices that allow the selection and recording of a regularly broadcast program for play back at a later time. This accommodates users that cannot watch the program during broadcast and users that desire to take breaks during viewing of a program without missing parts of the program.

It is known for the in-home computer industry to provide software that plays audio files on demand. Users can create audio file libraries by downloading files on the internet or by uploading files off of recorded media, such as compact discs. When downloading over the internet, the user visits a web site, selects one or more titles, and causes a downloading directed to the user's computer.

### SUMMARY OF THE INVENTION

Advantageously, this invention provides a method for entertaining a user using an entertainment device according to claim 1.

Advantageously, this invention provides an on-demand method of entertaining a user that allows the user to select between conventional entertainment and on demand entertainment. Advantageously, this invention allows a user to select the criteria for types of on-demand entertainment to be stored in the entertainment unit. The system and method provide background download of a plurality of entertainment items meeting the criteria and storage of those entertainment items, allowing the user to select from the plurality of stored entertainment items as an on-demand service.

Advantageously according to a first example, this invention provides an on-demand method of entertaining a user using an entertainment device comprising the steps of: providing a conventional entertainment to the user; monitoring a remote broadcast of for demand entertainment data; receiving the for-demand entertainment data; storing the received for-demand entertainment data; providing the operator with a selection of choices corresponding to the stored for-demand entertainment data; receiving a user input designating an entertainment choice from the selection of the choices corresponding to the stored for-demand entertainment data; using the stored for-demand entertainment data corresponding to the entertainment choice for to provide entertainment to the user.

Advantageously, according to another example, this invention provides a method for broadcast entertainment comprising the steps of: broadcasting first entertainment in a format allowing real-time reception and playing of the entertainment; broadcasting second entertainment in a format allowing reception and disallowing real-time playing of the entertainment; selectively receiving and playing the first entertainment for a user; selectively receiving and storing in a selectable storage library the second entertainment; selecting from the selectable storage library an item within the second entertainment; using the selected item from the storage library to entertain the user.

### BRIEF DESCRIPTION OF THE DRAWINGS

The present invention will now be described by way of example with reference to the following drawings, in which:

FIG. 1 illustrates an example system for implementing this invention;

FIG. 2 illustrates example entertainment unit components and functions according to this invention;

FIG. 3 illustrates example entertainment unit functions according to this invention;

FIG. 4 illustrates steps of an example method according to this invention; and

FIG. 5 illustrates steps of an example method according to this invention.

### DESCRIPTION OF THE PREFERRED EMBODIMENT

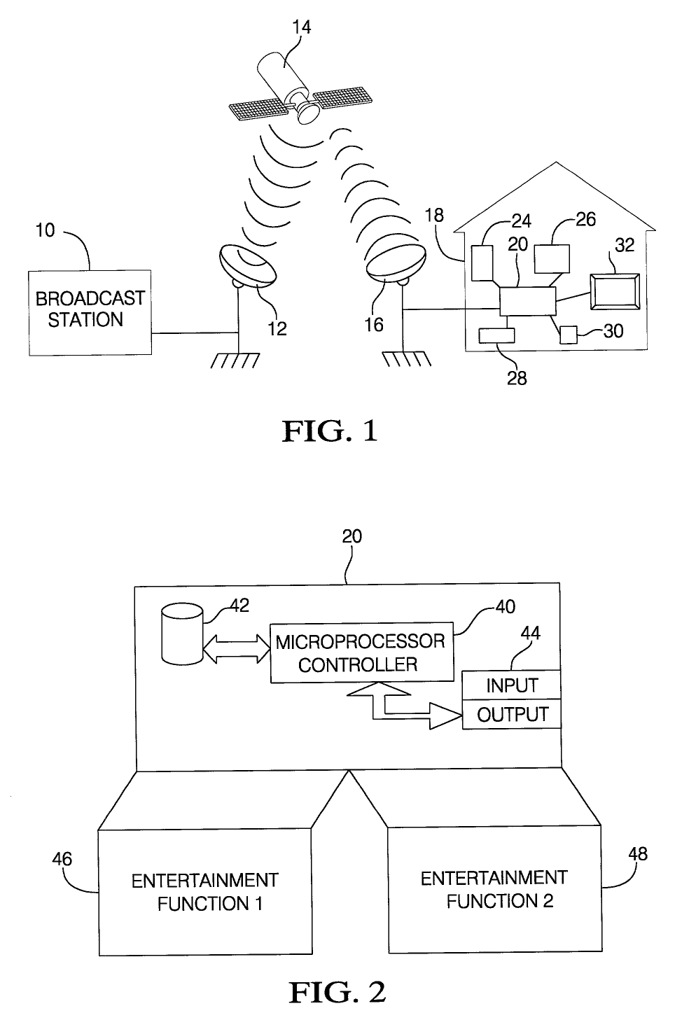

FIG. 1 illustrates an example system according to this invention including a broadcast station 10, satellite 14, satellite communication antennas 12 and 16 and entertainment unit 20. The entertainment unit 20 located, for example, within a home 18, is coupled to the television 32 or other type of video display device and in-home audio system 24 such as a stereo system. The entertainment unit 20 also interacts with at least one type of user interface such as a keyboard or key pad 28 and game hand unit 30. Additionally, the entertainment unit 20 may interact with a computer 26 to provide entertainment through the computer, including video, audio and/or internet access. In the examples below, functionality described may all be implemented using known technologies and techniques in accordance with the description herein.

The broadcast station 10 transmits through one or more ground-based transmitters having one or more satellite communication antennas 12 to one or more satellites 14. The transmissions from the broadcast station 10 include a first type of entertainment such as television or music entertainment in a format that allows real time reception at the home-based satellite communication antenna 16 and real time play through the entertainment unit 20 in audio and/or video format as appropriate for television 32 and/or, in the case of audio information, for an in-home audio system 24. One example of this first type of entertainment is subscription-based satellite television services such as is known and commercially available. The transmissions from the broadcast station 10 include a second type of entertainment comprising compressed data representing one or more entertainment items that allows reception at the home-based satellite communication antenna 16 and storage within the entertainment unit 20.

The satellites 14 receive and re-transmit the broadcasts from the ground-based transmitters for reception by the home satellite communication antennas 16. The antennas 12 and 16 and the satellites 14 may be configured to transmit in one direction only—from the broadcast station to the satellites 14 to the home antenna 16. In this case transmissions from the home 18 to the broadcast station 10 are through another channel 22 such as a telephone, cellular or internet connection. Alternatively, the antennas 12 and 16 and the satellites 14 may be configured to transmit bi-directionally.

In a preferred example, the entertainment unit 20 is an in-home game having capabilities of the type generally known in the field of in-home game units, including capabilities allowing users to play graphics-based arcade-style games and, optionally, DVD movies and audio compact discs. Other computer-based entertainment and functions may be included, such as internet web browsing and typical home personal computer functions.

The entertainment unit 20 is also an on-demand movie service giving the use the appearance of true on-demand movies. To provide the on-demand movie service, the entertainment unit provides the user with information, for example menus viewed through the television 32, allowing the user to make selections utilizing the interface 28, or alternatively the game hand unit 30. Through the menus the user picks movie types or in some examples, actual movie names, so that at the end of the selection criteria the entertainment unit has stored within it movie selection criteria.

The entertainment unit monitors satellite broadcasts received through antenna 16 for data representing movies being transmitted, for example, in bursts of compressed data, where the data is compressed to enable download and storage within entertainment unit. This compression format need not allow real-time play back of the movies being downloaded and, in a given implementation, may disallow real-time play back, for example, by sending data not in play-back order or by sending data before sending de-compression keys.

The entertainment unit 20 selects, from the satellite transmissions, the data representing components of movies of the type that meet the user's selection criteria and stores the selected data on a suitable storage device, such as a hard disk drive, within the entertainment unit 20. The data is stored in a manner and format that allows the user to select from any movie stored on the hard drive for play and display through the television 32 or other audio/video output devices. For example, the movie data may be stored on the hard disk drive in the format of DVD movies. If the system is set up for pay-for-play entertainment, then the entertainment unit communicates with the broadcast station 10 or a separate billing center to report the use of the on-demand entertainment service. The communication may either be at the time of use of the service, or periodically to report all uses during the previous time period. Billing office functions are then carried out to bill and obtain payment from the user.

The movie example is one type of entertainment and this invention equally applies to other types of television based entertainment, such as television shows, audio entertainment, arcade-style or other style interactive games, and software. Each of these types of entertainment are capable of (a) being downloaded in background, (b) being defined by user criteria, and (c) being stored and made available as on-demand entertainment.

Referring now to FIG. 2, a schematic of an example entertainment unit 20 is shown. The entertainment unit 20 includes a microprocessor-based controller 40 with at least one associated storage device 42 such as a hard disk drive capable of holding (a) control software for basic functions of the entertainment unit 20 that require software control, (b) virtual memory as necessary for use by the entertainment unit 20, and (c) stored entertainment such as is downloaded through satellite broadcasts as described above or such as is otherwise loaded into entertainment unit 20, for example, through an input/output interface 44. The input/output interface 44 accommodates all types of input and output required by the entertainment unit 20. For example, in the example where the basic functions of the unit are as a game device and an movie-on-demand service, the inputs and outputs accommodate the game hand unit 30, the television 32 and, if desired, the audio system 24. Additionally, the satellite signals must be accommodated as must be the communication of billing information (if implemented). Techniques for handling all of the required input/output interfaces for use with this invention are well known to those skilled in the art and will not be set forth in further detail herein.

The entertainment unit 20 has multiple entertainment functions 46, 48. For example, entertainment function 46 represents the game services such as described above and the entertainment function 48 represents the movie-on-demand services. The number of entertainment functions is limited only by the desires of the system designer and it is clear to those skilled of the art that many more entertainment services are possible, including playing broadcast entertainment such as television, radio, satellite radio, computer services, and other services such as playing DVD movies from DVD discs and CD audio from compact discs.

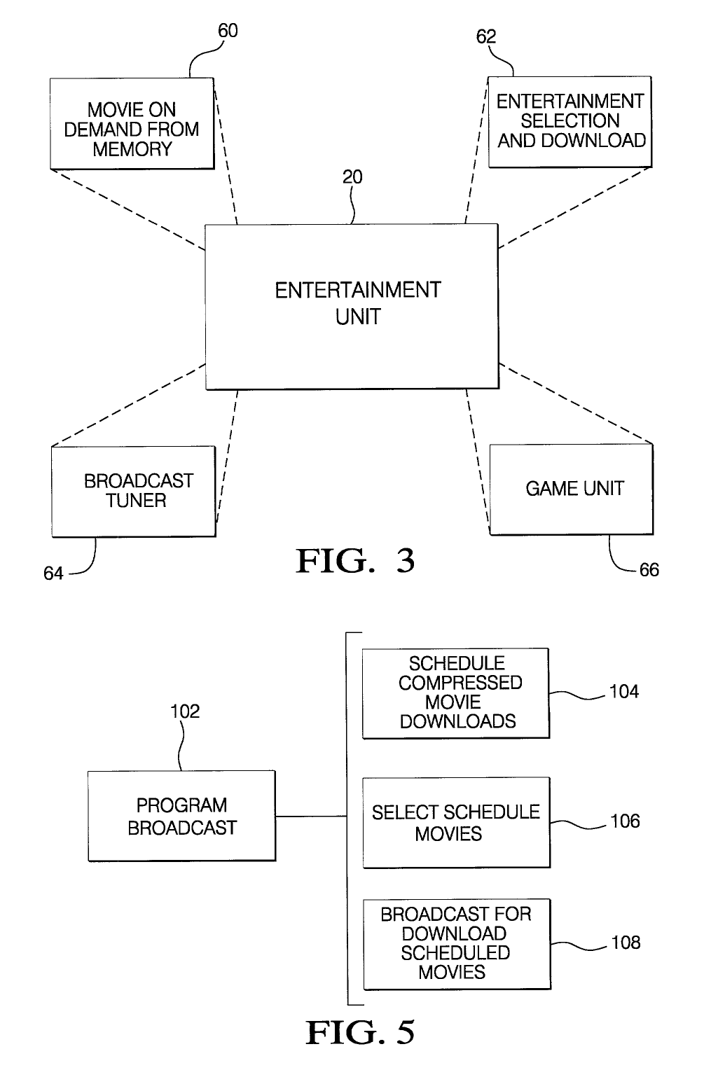

Referring now to FIG. 3, the example entertainment unit 20 is shown with representative functions according to this invention. The entertainment unit 20 includes the game unit 66, having capabilities of game units commercially available in stores. Box 62 represents the entertainment selection and download feature described above, including the provision of menus from which the user selects the desired types of entertainment. In the movie example, this is the selection of user desired movie types and, in some examples, specific movies. This function also represents the monitoring by the entertainment unit 20 of the satellite signals and the downloaded of entertainment, for example, movies, meeting the criteria selected by the user. Block 60 represents the movie-on-demand function through which the user may select, from the movies stored by the function 32 in memory, a movie for play back. Block 64 represents a broadcast tuner such as is commonly used in satellite reception systems for subscription satellite services. This function may be divided between a satellite signal decoder mounted on the antenna 16 (FIG. 1) and the television tuner, which may be located within the entertainment unit 20, or which may be the tuner within television 32 (as is known in the art).

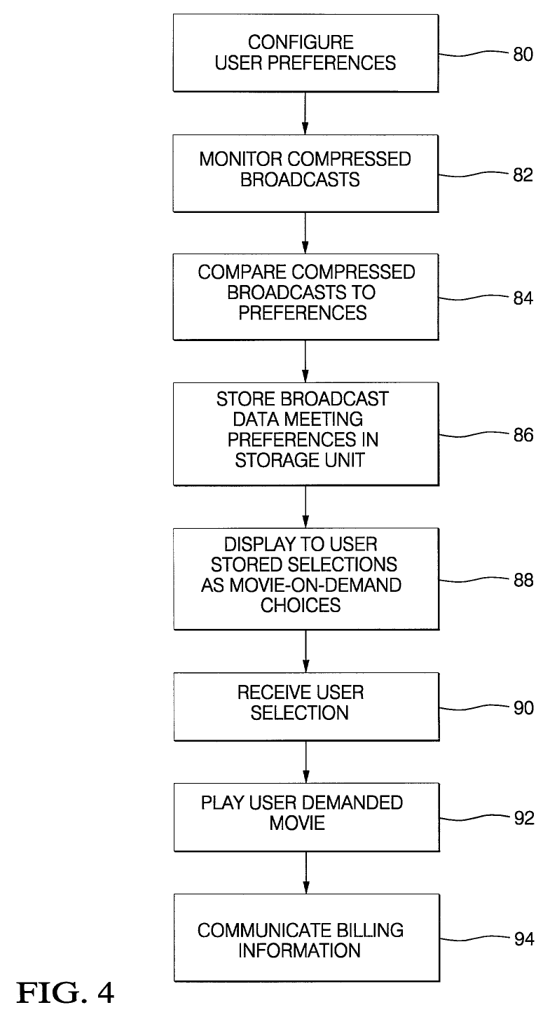

Referring now to FIG. 4, an example of the steps performed by the entertainment unit 20 according to this invention is shown. Block 80 represents the process for configuring user preferences such as described above the using menus that the user may interact with. Block 82 represents the function through which the unit 20 monitors the satellite (or cable or open air) broadcasts. The monitoring of the broadcasts may occur (a) during background—that is in a manner that is not apparent to the user while the user otherwise uses the entertainment unit 20, (b) at any time while the user is not using the entertainment unit 20, and/or (c ) only at selected times when entertainment unit 20 is not likely to be in use—such as during late night/early morning hours. Block 84 represents the step of comparing the compressed broadcast data to the preferences selected by the user at the step 80. Block 86 represents the steps of storing the broadcast data meeting the criteria designated by the preferences selected by the user at step 80. Block 86 is the step of displaying to the user stored selections recorded at block 86, so that the user understands that these selections are movie (or other entertainment) on demand choices from which the user may select a movie for immediate play or other entertainment for immediate use. Block 90 represents the step of receiving the user's selection from the choice of movies (or other entertainment). Block 92 represents the step of playing the user selected movie (or other user-selected entertainment). And block 94 represents the step of communicating billing information from the unit 20 to the broadcast station 10 (FIG. 1) or elsewhere if billing functions are not performed at the broadcast station 10. It is understood that step 94 applies only to systems that require billing based on user-demanded services received by the user.

Referring now to FIG. 5, an example of the steps performed by the broadcast station 10 (FIG. 1) according to this invention is shown. Block 102 represents program broadcasts such as is conventionally performed by subscription based satellite broadcast companies. Alternatively, the program broadcast is performed by a cable broadcast company or over open air broadcast. In both examples, the broadcasts are made available to all users (even if some are restricted by conventional pay-per-view methods where the in-home unit blocks play of movies not paid for). Block 104 represents the step of scheduling compressed movie (or other entertainment) downloads, representing broadcasts of data meant to be stored in entertainment unit 20 (FIG. 1) for on demand services. Block 106 represents the step of selecting the scheduled movies (or other entertainment) for broadcast. And block 108 represents the step of broadcasting for down the scheduled movies (or other entertainment). The movies or entertainment are compressed and transmitted, for example, in blocks of data. All users with in-home entertainment units 20 have the capability of receiving the blocks of compressed data and the in-home units select which data to store for on-demand playback. The broadcasts are not in response to request from users and occur even without feedback of criteria from users, but the scheduling of particular entertainment items may occur in response to user selections as described above.

As is apparent to those skilled of the art, the scheduling of movies (or other entertainment) for downloading takes into account all types of movies (or other entertainment) desired by users and, for example, designates primary download time for more popular movies such as new releases, and designates secondary download time to less popular movies. Complete satisfaction of user desires can be accomplished by having the entertainment unit 20 communicates user selections to the broadcast station 10 or other office where scheduling occurs. The scheduling of movies (or other entertainment) can then be based on actual user input to ensure satisfaction of all user desires.

In the description above, conventional entertainment means any type of known entertainment, including but not limited to broadcast programming, interactive games, computer services, DVD, VHS and Beta movie services, and audio compact disc services.

1. An on-demand method of entertaining a user using an entertainment device comprising the steps of:
providing graphics-based games with user interaction with the entertainment device;
monitoring a remote broadcast of compressed movie data;
receiving the compressed movie data;
storing the received compressed movie data in the entertainment device;
providing the operator with a plurality of choices corresponding to stored movie data;
receiving a user input designating a movie choice representing one of the choices corresponding to stored movie data;
using the stored movie data corresponding to the designated movie choice to play a movie for the user.

2. The method of claim 1, also comprising the step of receiving in the entertainment unit, from the user, a criteria indicating desired types of movies, wherein the step of storing the received compressed movie data stores only that compressed movie data meeting the criteria.

3. An on-demand method of entertaining a user using an entertainment device comprising the steps of:
providing a conventional entertainment to the user;
monitoring a remote broadcast of for-demand entertainment data; receiving the for-demand entertainment data;
storing the received for-demand entertainment data;
providing the operator with a selection of choices corresponding to stored for-demand entertainment data;
receiving a user input designating an entertainment choice representing one of the choices corresponding to stored for-demand entertainment data;
using the stored for-demand entertainment data corresponding to the designated entertainment choice to provide entertainment to the user.

4. The method of claim 1, also comprising the step of receiving in the entertainment unit, from the user, a criteria indicating desired types of movies, wherein the step of storing the received compressed movie data stores only that compressed movie data meeting the criteria.

5. The on-demand method of entertaining a user of claim 2, wherein the step of monitoring the remote broadcast is carried out as a background function not apparent to the user.

6. The on-demand method of entertaining a user of claim 2, wherein the step of monitoring the remote broadcast is carried out when the user is not using the entertainment device.

7. The on-demand method of entertaining a user of claim 2, wherein the remote broadcast is transmitted through a satellite.

8. The on-demand method of entertaining a user of claim 2, wherein the for-demand entertainment data comprises a plurality of movies.

9. The on-demand method of entertaining a user of claim 2, wherein the for-demand entertainment data comprises a plurality of audio files.

10. The on-demand method of entertaining a user of claim 2, wherein the for-demand entertainment data comprises a plurality of user-interactive games.

11. An on-demand method for broadcast entertainment comprising the steps of:
broadcasting first entertainment in a format allowing real-time reception and playing of the entertainment;
broadcasting second entertainment in a format allowing reception and disallowing real-time playing of the entertainment;
selectively receiving and playing the first entertainment for a user;
selectively receiving and storing in a selectable storage library the second entertainment;
selecting from the selectable storage library an item within the second entertainment;
using the selected item from the storage library to entertain the user.

12. An on-demand system for entertaining a user comprising:
an entertainment device providing a conventional entertainment to the user and a microprocessor-based system for monitoring a remote broadcast of for demand entertainment data, receiving the for-demand entertainment data, storing the received for-demand entertainment data, providing the operator with a selection of choices corresponding to stored for-demand entertainment data, receiving a user input designating an entertainment choice representing one of the choices corresponding to stored for-demand entertainment data, using the stored for-demand entertainment data corresponding to the entertainment choice for to provide entertainment to the user.

13. An on-demand system for entertaining a user comprising:
a game unit providing a conventional games to the user and including a microprocessor-based system for monitoring a remote broadcast of for-demand movie data, receiving the for-demand movie data, storing the received for-demand movie data, providing the operator with a selection of choices corresponding to stored for-demand movie data, receiving a user input designating a movie choice representing one of the choices corresponding to stored for-demand movie data, using the stored for-demand movie data corresponding to the designated movie choice do play the designated movie choice for the user.
